(19) United States
(12) Patent Application Publication
(10) Pub. No.: US 2007/0170662 A1
(43) Pub. Date: Jul. 26, 2007

(54) Seal assembly for fluid components

(76) Inventors: Peter C. Williams, Cleveland Heights, OH (US); Mark A. Bennett, Bainbridge Township, OH (US); George A. Carlson, Ravenna, OH (US); Theodore J. Gausman, Concord, OH (US); Joseph J. Jagielo, South Euclid, OH (US); Timothy J. Maruna, Chardon, OH (US); Douglas A. Nordstrom, Shaker Heights, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/590,646

(22) PCT Filed: Feb. 28, 2005
(86) PCT No.: PCT/US05/06469

§ 371 Date: Aug. 25, 2006

Related U.S. Application Data
(60) Provisional application No. 60/521,154, filed on Feb. 28, 2004.

(51) Int. Cl. F16J 15/08; H02G 15/013

(52) U.S. Cl. 277/627

(57) ABSTRACT

A seal (10) includes a seal structure (130) for engagement with first (24) and second fluid components (26) in first (84) and second counterbores (88). The seal also includes a holding plate (20, 30) structure for engagement with first (81) and second surfaces (85) of the components. The holding plate structure includes one or more layers that are preferably formed with the outer layers of the seal structure (30). The seal structure preferably includes at least three abutting layers of metal, the inner layer (70) having a hardness that is selected to be greater than the hardness of the first and second outer layers (20, 30). The invention also relates to a method of achieving a metal to metal seal between two relatively hard metal components in a fluid System.

### RELATED APPLICATION

This application claims the benefit of U.S. Provisional Application No. 60/521,154 filed Feb. 28, 2004, the entire disclosure of which is hereby incorporated by reference.

### BACKGROUND OF THE INVENTION

The present invention relates to a seal, or seal assembly, for a fluid component. The seal, or seal assembly, may be used to seal between fluid components in a fluid system, such as a modular surface mount fluid system as shown in U.S. Published Application No. 2002/0000256A1, dated Jan. 3, 2002, for example, the entire disclosure of which is hereby incorporated by reference.

FIGS. 1-3 illustrate portions of the modular surface mount fluid system of U.S. Published Application No. 2002/0000256A1. The system includes one or more fluid components, designated “a” (FIG. 1). The components may be filters, valves, flow meters, regulators, etc., that are mounted on a base or substrate designated “b”. The components “a” communicate with ports “c” in the base “b”. A bridge fitting beneath the substrate may direct fluid to flow between the components. Circular metal seals “d” create a seal between the components “a” and the substrate “b”, at the location of the ports “c”. The seals “d” are shown in more detail in FIGS. 2 and 3, which show that the seals have a C-shaped cross-sectional configuration. Such seals are commonly known as “C-seals”.

These C-seals are, for installation between the component and the base, sometimes provided on a seal retainer, for example, as shown in FIG. 1A. Seals of this general type are shown, for example, in U.S. Pat. Nos. 5,713,582; 5,730,448; 5,735,532; and 6,015,152. A seal retainer is a thin plate that is fitted between the component and the base, and that has fingers or prongs or other structure for supporting one or more of the C-seals. The use of the retainer makes the proper installation of the seals easier and more accurate, as it requires only proper positioning of a relatively large (1⅛″ or 1¼″ square) plate, rather than proper positioning of a relatively small (¼″ diameter) seal itself. In these devices, the seals are separate pieces from the retainers, and are assembled onto the retainers before placement of the assembly into its final location between the fluid component and the base.

Another type of prior art metal seal, for use in the same application, is known as a Tytan seal and is manufactured by Perkin-Elmer Corporation. This type of seal is also sold by Swagelok Company of Solon, Ohio. FIG. 4 is a cross-sectional view, similar to FIG. 3, of a Tytan seal shown between two structures, e.g., a fluid component and a base. The cross-sectional configuration of the Tytan seal is a variation on a C-shape, with a more squared-off shape and a V-shaped notch between the two legs of the seal.

### SUMMARY OF THE INVENTION

In one aspect, the invention relates to a seal that includes a seal structure and a holding plate structure. The seal structure and the holding plate structure are preferably formed together for assembly between two fluid components. The seal structure preferably includes at least three abutting layers of metal including first and second outer layers having a relatively great hardness and an inner layer having lesser hardness.

In another aspect, the invention relates to a seal for sealing between first and second fluid flow components when the components are joined to each other, the first component having a first counterbore in a first surface and the second component having a second counterbore in a second surface, when the components are joined to each other the first surface overlying the second surface and the first counterbore overlying the second counterbore. The seal includes a seal structure for engagement with the first and second fluid components in the first and second counterbores. The seal also includes a holding plate structure for engagement with the first and second surfaces of the first and second fluid components. The holding plate structure includes one or more layers that are formed with the first and second outer layers of the seal structure.

In another aspect, the invention relates to a seal for sealing between first and second fluid flow components when the components are joined to each other, the first component having a first counterbore in a first surface and the second component having a second counterbore in a second surface, when the components are joined to each other the first surface overlying the second surface and the first counterbore overlying the second counterbore. The seal includes a seal structure for engagement with the first and second fluid components in the first and second counterbores. The seal also includes a holding plate structure connected with the seal structure for engagement with the first and second surfaces of the first and second fluid components. The seal structure includes at least three abutting layers of metal including first and second outer layers for engagement with the first and second fluid components and an inner layer, the first and second outer layers having a hardness that is selected to be less than the hardness of the counterbores of the first and second components, the inner layer having a hardness that is selected to be greater than the hardness of the first and second outer layers. The inner layer of the seal structure transmits force between the outer layers when the components are joined together with the seal structure in the counterbores.

The invention also relates to a method of achieving a metal to metal seal between two relatively hard metal components in a fluid system, comprising the steps of providing a metal seal that includes a seal structure and a holding plate structure, the seal structure including two relatively soft seal elements and one relatively hard seal ring captured between the seal elements; placing the seal between the two fluid system components so that the two seal elements sealingly engage counterbores of the fluid system components with the seal ring between them thereby providing a stack of metal members that are arranged in a hard, soft, hard, soft, hard order; and transmitting force through the stack of metal members to maintain a seal between the fluid components without contact between the fluid components and the relatively hard seal ring.

### BRIEF DESCRIPTION OF THE DRAWINGS

FIG. 1 is a pictorial view of a prior art modular fluid system that includes fluid components that can be sealed by seals constructed in accordance with the present invention;

FIG. 1A is a pictorial view of a portion of another prior art modular fluid system that includes fluid components that can be sealed by seals constructed in accordance with the present invention;

FIG. 2 is a sectional view of a portion of the prior art system of FIG. 1 showing the prior art seal between two fluid components;

FIG. 3 is an enlarged view of the prior art seal of FIG. 2;

FIG. 4 is a sectional view similar to FIG. 3 of another prior art seal;

FIG. 5 is a sectional view, generally similar to FIG. 2, of a portion of a seal assembly in accordance with a first embodiment of the invention and shown in a modular fluid system and sealing between two fluid components;

FIG. 6 is perspective view of the complete seal assembly of FIG. 5;

FIG. 7 is an exploded perspective view showing the seal assembly of FIG. 6 being assembled between two components;

FIG. 8 is a cutaway perspective view of a portion of the seal assembly of FIG. 6;

FIG. 9 is a plan view of the seal assembly of FIG. 6;

FIG. 10 is an exploded perspective view of the seal assembly of FIG. 6;

FIG. 11 is an enlarged sectional view showing a portion of the seal assembly of FIG. 6, prior to being assembled;

FIG. 12 is an enlarged sectional view similar to FIG. 11 showing the seal assembly portion of FIG. 6 in an assembled condition;

FIGS. 12A and 12B illustrate a finite element analysis of the seal assembly portion of FIG. 6 in an assembled condition;

FIGS. 13 and 14 are views of a seal assembly in accordance with a second embodiment of the invention;

FIGS. 15 and 16 are views of a seal assembly in accordance with a third embodiment of the invention;

FIGS. 17 and 18 are views of a seal assembly in accordance with a fourth embodiment of the invention;

FIGS. 19 and 20 are views of a seal assembly in accordance with a fifth embodiment of the invention;

FIGS. 21 and 22 are views of a seal assembly in accordance with a sixth embodiment of the invention;

FIGS. 23 and 24 are views of a seal assembly in accordance with a seventh embodiment of the invention;

FIGS. 25 and 26 are views of a seal assembly in accordance with an eighth embodiment of the invention;

FIGS. 27 and 28 are views of a seal assembly in accordance with a ninth embodiment of the invention; and

FIGS. 29 and 30 are views of a seal assembly in accordance with a tenth embodiment of the invention.

### DETAILED DESCRIPTION OF THE INVENTION

The present invention relates to a seal, or seal assembly, for a fluid component, the fluid being a gas or a liquid. As one example, the seal, or seal assembly, may be used to seal between fluid components in a fluid system, such as a modular surface mount fluid system as shown in U.S. Published Application No. 2002/0000256A1, dated Jan. 3, 2002, for example, the entire disclosure of which is hereby incorporated by reference. The invention is no limited to the embodiments or uses illustrated herein, which are only exemplary.

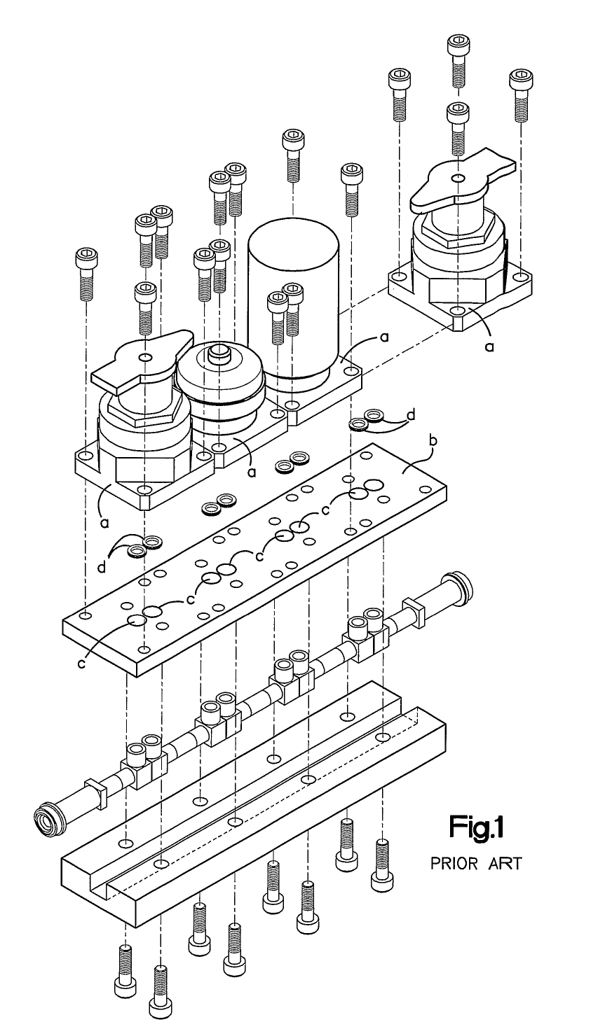

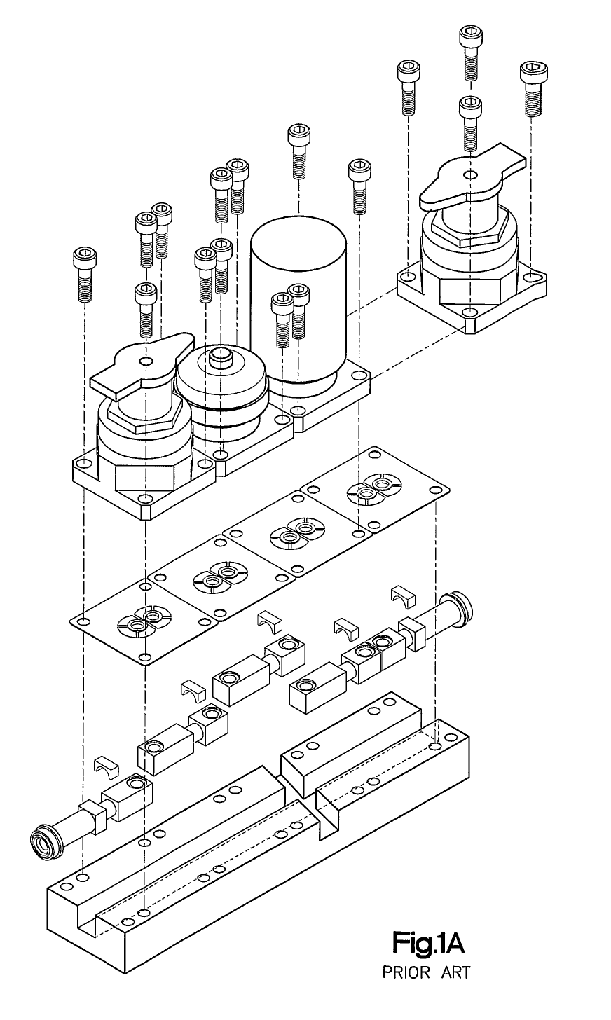

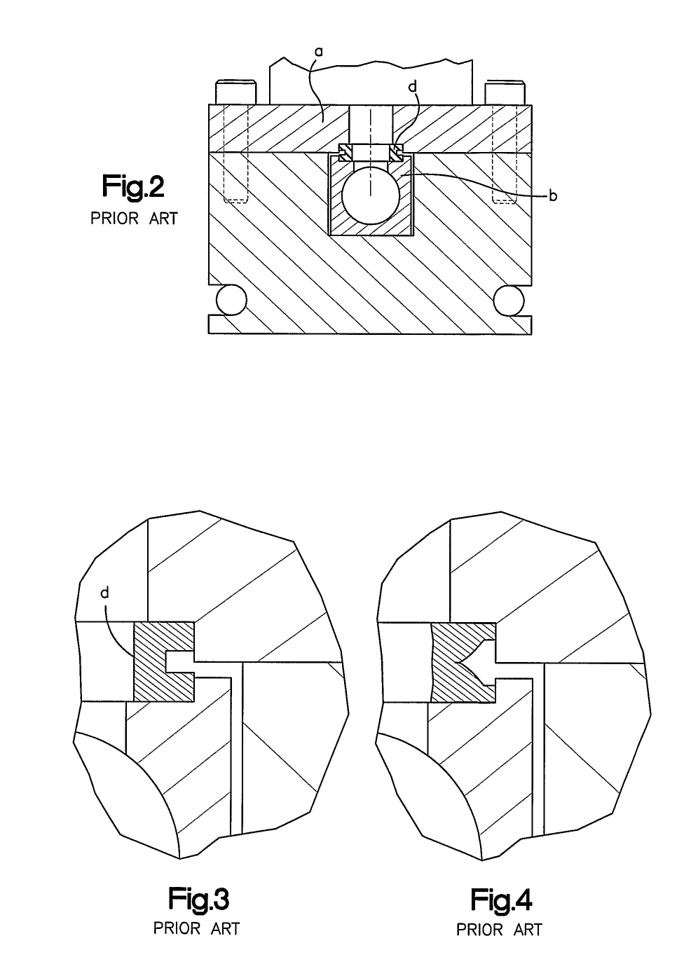

FIGS. 5-12 herein illustrate a seal or seal assembly 10, for use in the type of fluid system application shown in FIGS. 1-4, that is constructed in accordance with a first embodiment of the invention.

The seal assembly 10 shown in FIGS. 5-12 is made up of first and second members 20 and 30, and a ring 70. The two members 20 and 30 are preferably stainless steel stampings, although they could be made from a different material, and they could be made in a manner other than by stamping. The stampings 20 and 30 are welded together to form a ring holder 22, with the ring 70 sandwiched between them, as described below. The completed seal assembly 10 can be placed between two fluid components 24 and 26, for example, as shown in FIG. 7, to form seal between the components. A preferred material for the components 24 and 26 is stainless steel, specifically, 316 stainless steel. As thus formed, the seal assembly 10 replaces two adjacent seals “d” shown in FIG. 1, between one of the components “a” and the base plate “b”. Seal assemblies in accordance with the present invention can include a plurality of seals, or one seal only.

The first and second stampings 20 and 30 are identical to each other; only the one stamping 20 is described in detail. The material from which the stampings 20 and 30 is made is softer than the material of the components 24 and 26. A preferred material for the stampings 20 and 30 is stainless steel, specifically, 316 stainless steel.

The stamping 20 includes a plate portion 28 that has a generally X-shaped configuration including four arms 32 that extend outward from a central section 34. The four arms 32 lie in a common plane 36 (FIG. 11) along with a portion of the central section 34.

Each one of the four arms 32 has, at its outer end, a circular fastener opening 38. The four fastener openings 38 are arranged in a pattern that matches the pattern of fastener openings 37 in the component 24 and fastener 39 openings in the base 26. Thus, the stamping 20 is adapted to be captured and fastened between the component 24 and the base 26 when they are fastened together.

The central section 34 of the stamping 20 has two circular fluid flow openings 40. The openings 40 align with two fluid flow passages 42 in the base 26 and with two fluid flow ports (not shown) in the component 24, when the stamping 20 is fastened between the components 24 and 26 in the manner described above.

Around each one of the fluid flow openings 40, the material of the central section 34 of the stamping 20 is bent out of the plane 36 to form a seal circular arm 50 that is formed with the other portions of the stamping. The seal arm 50 preferably is formed as illustrated by stamping from the same piece of material as the other portions of the member 20. Alternatively, the seal arm 50 could be initially formed separately from the other portions of the member 50 then joined thereto, for example by welding. In this manner, the seal arm is formed with and thereby movable with the other portions of the member 20 during assembly of the seal into the fluid system as described below. The seal arm 50 includes a compound curved connector portion 52 that extends upward (as viewed in FIG. 11) from the plane 36. A generally planar, annular, inner peripheral portion 54 of the seal arm 50 extends parallel to the plane 36. The inner peripheral portion 54 has inner and outer side surfaces 56 and 58. The inner peripheral portion 54 has an inner terminal edge 60 that defines the fluid flow opening 40 in the stamping 20.

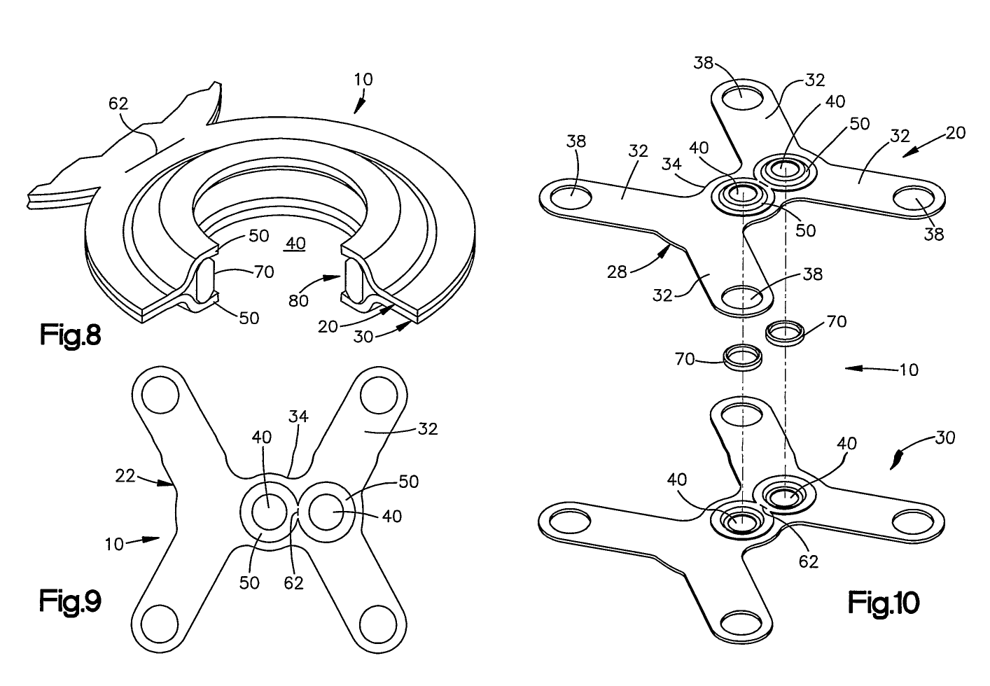

A slit 62 (FIG. 8) may be provided in the stamping 20 between adjacent seal elements, to facilitate material movement during manufacturing and stack-up tolerances between adjacent elements in use.

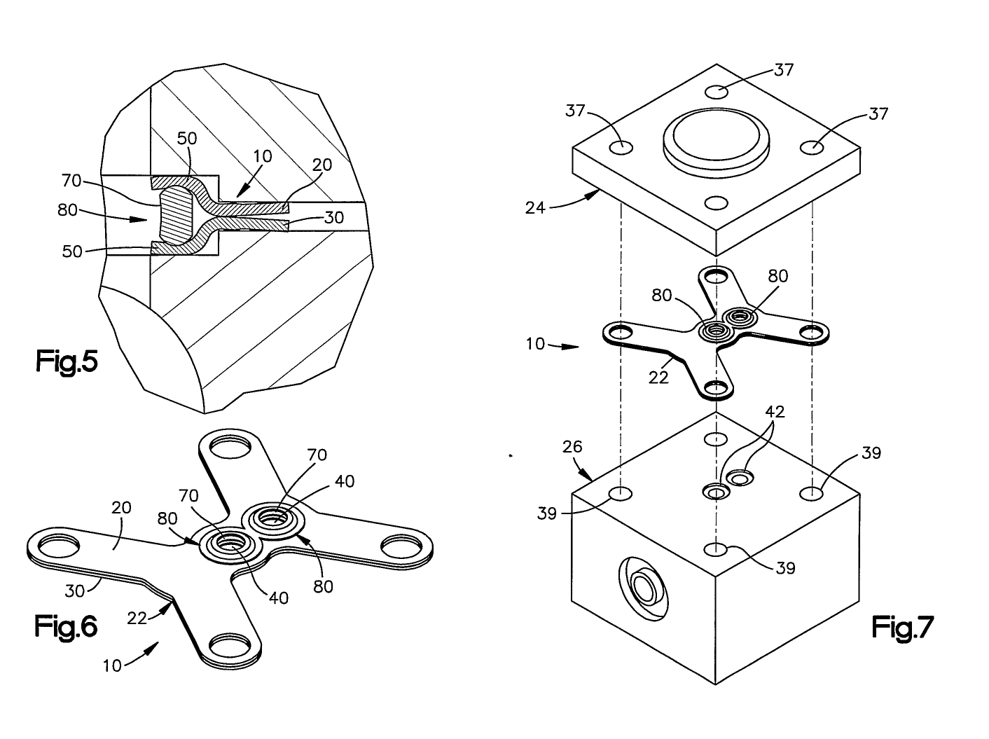

Because the second stamping 30 is identical to the first stamping 20, when the two stampings are assembled together as shown in FIGS. 6 and 11, an annular ring volume 66 is defined between the two stampings. Specifically, the ring volume 66 is defined between the connector portion 52 and the inner peripheral portion 54 of the seal arm 50 of the first stamping 20, on the one hand, and the connector portion 52 and the inner peripheral portion 54 of the seal arm 50 of the second stamping 30, on the other hand.

The ring 70 is located in the ring volume. The ring 70 is made separately from the stampings 20 and 30, from a harder material than the stampings 20 and 30. A preferred material is stainless steel.

The ring 70 has a circular shape as viewed in plan (FIG. 7). The ring 70 has a generally oval cross-sectional configuration including curved upper and lower peripheral surfaces 72 and 74 that are joined by parallel, cylindrical, radially inner and outer side surfaces 76 and 78.

The parts of the seal device 10 are preferably joined together at a location remote from the fluid system and prior to placement of the seal assembly into the fluid system. The two stampings 20 and 30 are positioned together as shown in FIGS. 5 and 6, with the first stamping overlying the second stamping. The ring 70 is located between the two stampings 20 and 30. The two stampings 20 and 30 are secured together, preferably by welding, or possibly in another suitable manner.

When the two stampings 20 and 30 are thus joined to each other to form the ring holder 22, the ring 70 is clamped between the seal arms 50 of the two stampings. The resilience of the seal arms 50 of the stampings 20 and 30 holds the ring 70 in the ring cavity 66. The two seal arms 50, together with the ring 70, form a seal structure or seal 80. The seal structure 80 includes three layers of metal in abutting engagement, the softer outer layers (seal arms 50) of the stampings 30 and the harder inner layer that is the ring 70.

Because of the configuration of the two seal arms 50 of the stampings 20 and 30, it is physically impossible for the ring 70 to come out of the ring volume 66 of the assembly 10, unless the ring holder 22 is seriously deformed. Further, as described above, the seal arms are formed with the other portions of the members 20 and 30, either manufactured integrally initially or joined thereto by welding, for example, prior to assembly with the first and second components. As a result, the completed seal assembly 10 including the two members 20 and 30 and the ring 70 can be shipped and handled and assembled as one piece. There is no need for the installer to handle the ring 70 or the seal arms 50 separately, or to worry that the ring might fall off or out of the ring holder 22.

The arms 32 of the plates 20 and 30 together form a preferably planar or preferably generally planar holding plate structure that can be used to hold and position the seal structure during assembly of the system. The seal arms 50 of the seal structure 80 are formed with the layers of the holding plate structure and, preferably, as shown in the illustrated embodiment, are formed as one piece with the layers of the holding plate structure. The seal arms 50 project out of the plane of the holding plate structure which in this embodiment includes two layers of metal that are portions of the two pieces of metal (stampings in this case) 20 and 30. In other embodiments, for example as described below, the holding plate structure may be only one layer of metal.

FIG. 7 illustrates placement of the seal assembly 10 in a modular surface mount fluid system. Specifically, FIG. 7 illustrates placement of the seal assembly between the two components 24 and 26. The components 24 and 26 may be a base and a component as shown in FIG. 1, for example. The seal assembly 10 is adapted for this use by virtue of having the standardized placement of the four fastener openings 38 and of the two fluid flow openings 40, as described above. Seals assemblies in accordance with the present invention may have other configurations, of course.

The four fastener openings 38 at the ends of the arms 32 of the ring holder 22 align with the fastener openings 37 and 39 in the components 24 and 26, respectively. The two fluid flow passages 40 in the seal assembly align with the fluid flow passages in the first component 24 and with the fluid flow passages 42 in the second component 26.

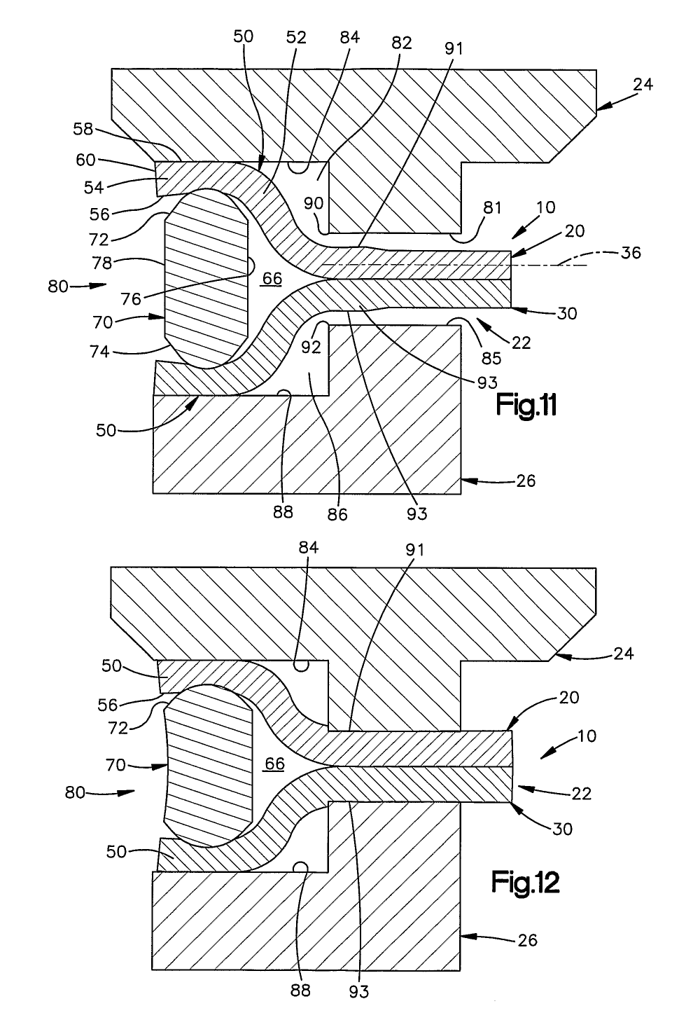

The first component 24 has a planar first surface 81 in which is formed a first counterbore 82 (FIGS. 11 and 12) that encircles its fluid flow passage 42. The counterbore 82 is partially defined by an annular, radially extending planar surface 84 and a cylindrical surface. The second component 26 has a planar second surface 85 in which is formed a corresponding counterbore 86 that encircles its fluid flow passage 42. The counterbore 86 is partially defined by an annular, radially extending planar surface 88 that extends parallel to the surface 84.

When the two components 24 and 26 are placed together with the seal assembly 10 between them, the seal arms 50 of the two stampings 20 and 30, and the ring 70, are received in the cavity defined by the two counterbores 82 and 86. The outer side surface 58 of the seal arm 50 of the first stamping 20 is engaged by the radially extending surface 58 of the first component 24. The outer side surface 58 of the seal arm 50 of the second stamping 30 is engaged by the radially extending surface 88 of the second component 26.

As the two components 24 and 26 move closer to each other, the planar surfaces 84 and 88 exert a clamping force on the seal arms 50 of the two stampings. This clamping force is transmitted between the two relatively hard components 24 and 26, through the two relatively soft stampings 20 and 30, and through the relatively hard ring 70. The clamping force exerted by the two components 24 and 26 causes the two stampings 20 and 30, which are softer than the ring 70 and softer than the components, to be sealingly deformed. The parts of the assembly 10 move from the partially assembled condition shown in FIG. 11 to the fully assembled condition shown in FIG. 12.

The arcuate surface 72 of the ring 70 presses against the inner side surface 56 of the seal aim 50 of the first stamping 20. The arcuate surface 74 of the ring 70 presses against the inner side surface of the seal arm 50 of the second stamping 30. Because the ring 70 is harder than the stampings 20 and 30, the material of the seal arms 50 of the stampings is deformed and spreads out as shown in FIG. 12. In addition, the engagement of the seal arms 50 with the components 24 and 26 causes is a small amount of plastic deformation of the material of the planar surfaces 84 and 88 of the components. Still further, because the stampings 20 and 30 are very thin, the clamping force transmitted through them produces a high localized stress concentration on the components. These factors together produce an effective seal against the components 24 and 26. FIGS. 12A and 12B show a finite element analysis of the seal assembly portion of FIG. 6 in an assembled condition, illustrating these factors.

The force exerted by the ring 70 on the stampings 20 and 30 spreads out enough to avoid significant damage to the surfaces 84 and 88 of the components 24 and 26, respectively, while at the same time staying concentrated enough to provide the localized stress concentrations, as needed to effect a good metal to metal seal. The amount of deformation of, or damage to, the surfaces 84 and 88 of the components 24 and 26 is relatively low, specifically, low enough that the components can be reused many times while replacing only the seal assemblies 10.

Clamping the seal assembly 10 in position as shown in FIG. 27 causes the parts to be stacked in an order of hard (component 24) to soft (seal arm 50) to hard (ring 70) to soft (seal arm 50) to hard (component 26).

A corner 90 of the component 24 indents the first stamping 20, and a corner 92 of the component 26 indents the second stamping 30, to resist or prevent shear slip of the parts. The stampings may be provided with raised land areas 91, 93 adjacent the seal arms that are compressed when clamped, as shown in FIG. 12, to enhance this function.

The seal assembly 10 forms a solid structure that transmits force from the first component 24 through the first seal arm 50 and the ring 70 and through the second seal arm 50 to the second component 26. In comparison, the C-seal “d” shown in FIG. 3 has a gap between the two legs of the C, and the legs themselves are resilient. When the clamping force on the C-seal “d” is increased to its final assembled level, the legs of the C configuration deform inwardly toward each other, and there is nothing between them to resist this deformation. As a result, the only force acting to hold the legs of the C configuration outward against the counterbores is the resilience of the material of the C-seal “d”. This is not as effective a force transmission device as is the solid structure provided by the seal assembly 10 shown in FIGS. 5-12, in which the ring 70 acts as a hard, solid backstop to the two stampings 20 and 30—that is, to the portions of the assembly that engage the counterbore surfaces 84 and 88).

The invention thus provides a seal assembly 10 in which the seals 80 are formed with or integral with the holder 22. The ring holder 22 is easily formed as one or more metal stampings. The ring holder 22 is made from a softer material than the components 24 and 26, to avoid damage to the components. The seal 80 is selectively hardened by putting a hard ring 70 inside the soft ring holder 22. The ring holder 22 is made of two stampings 20 and 30 back to back that together enclose a ring 70. Each stamping forms a half of the relatively soft portion 22 of the seal 80, that seals against one of the two counterbore surfaces 84 or 88. The outer surface portion 50 of the seal 80 is thus softer than the inner portion 70.

FIGS. 13 and 14 illustrate a seal assembly in accordance with a second embodiment of the invention. The seal assembly 10a may be used in place of the seal assembly 10, to seal between the same two components 24 and 26, or between other components. As illustrated in FIG. 13, the seal assembly seals between the same two components 24 and 26, in place of the seal assembly 10 of FIGS. 5-12. Parts of the seal assembly 10a that are similar in function or configuration to parts of the seal assembly 10 are given the same reference numerals, with the suffix “a” added to distinguish them.

The seal assembly 10a includes a ring 70a that is the same as or similar to the ring 70 (FIGS. 5-12). The seal assembly 10a includes a ring holder 22a that includes only one stamping 100, however, rather than the two stampings used in the seal assembly of FIGS. 5-12.

The one stamping 100 (FIGS. 13 and 14) has an overall configuration that is generally similar to the configuration of each of the two stampings of the first embodiment. In FIGS. 13 and 14 only a portion of the stamping 100, around the fluid flow opening 40, is shown. The stamping 100a has a central section 34a that includes a seal arm 50a that wraps around both curved surfaces 72a and 74a of the ring 70a. The seal arm 50a thus has a first arm portion 102 in engagement with the curved surface 72a of the ring 70a, and a second arm portion 104 in engagement with the curved surface 74a of the ring. The terminal end 106 of the seal arm 50a is located radially outward of the ring 70a.

As a result, the seal arm 50a has a “hook” configuration. The seal arm 50a defines a ring cavity 66a. The seal arm 50a encloses and captures the ring 70a in the ring cavity 66a. The seal assembly 10a thus includes a one-piece ring holder 27a, and a seal 80a that is formed of the one seal arm 50a and the ring 70a. As in the first embodiment, the stamping 100 is made from a softer material than the ring 70a and the components 24 and 26.

When the seal assembly 10a is placed between the two components 24 and 26 as shown schematically in FIG. 13, the first seal arm portion 102 engages the counterbore surface 84a of the first component 24, and the second seal arm portion 104 engages the counterbore surface 88 of the second component 26. When the two components 24 and 26 are brought together (not shown), the seal assembly 10a is clamped between the counterbore surfaces 84 and 88 of the components. Clamping force is transmitted from the first component 24 through the first seal arm portion 102, the ring 70a, and the second seal arm portion 104, to the second component 26.

The seal 80a seals between the components 24 and 26 in a manner similar to that of the seal assembly 10. Specifically, the softer material of the seal arm portions 102 and 104 deforms between the ring 70a and the components 24 and 26. This deformation spreads the clamping force over a relatively large surface area of the components 24 and 26, via a relatively soft material, to minimize deformation of or damage to the components. At the same time, the hard ring 70a provides a backstop for firmly transmitting the clamping force across the two counterbores and thereby effect a good seal.

This second embodiment of the invention thus provides a seal assembly that includes a ring holder made from a single stamping, that encloses a ring. The stamping is softer than the ring. The ring is sandwiched between curved seal arm portions of the stamping. The relatively soft seal arm portions seal against the harder components, with the relatively hard ring between them as a backstop to transmit force and thus maintain the seal between the components.

FIGS. 15-28 illustrate seal assemblies in accordance with additional embodiments of the invention. The seal assemblies may be used in place of the seal assembly 10a, to seal between the same two components 24 and 26, or between other components. In each case, the seal assemblies shown in FIGS. 15-28 are illustrated as sealing between the same two components 24 and 26.

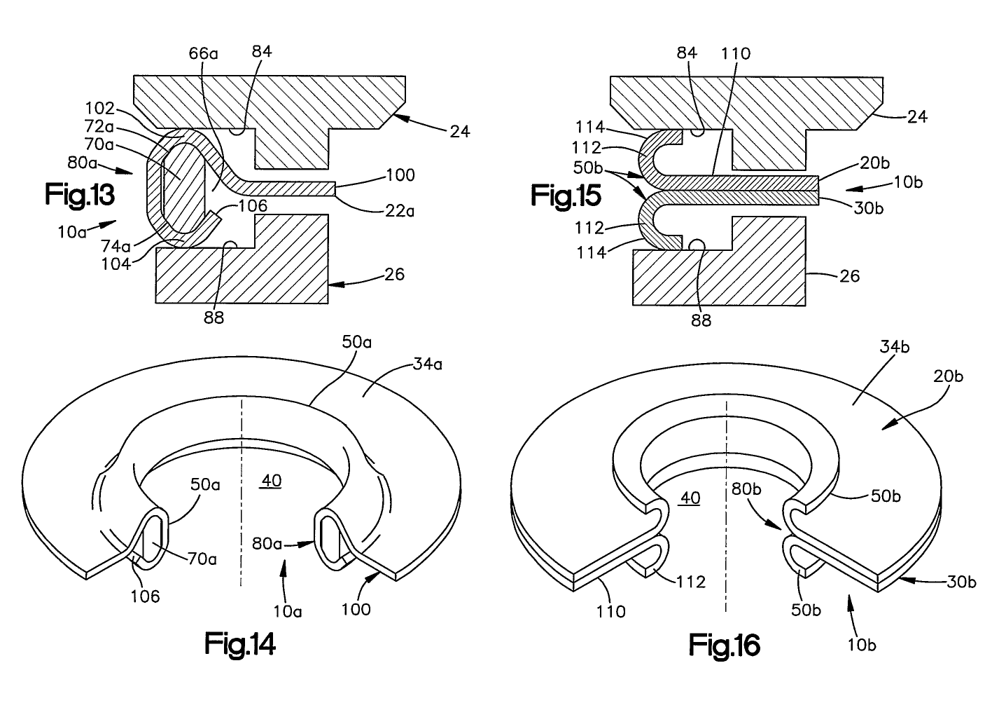

FIGS. 15 and 16 illustrate a seal assembly 10b in accordance with a third embodiment of the invention. The seal assembly 10b includes the two stampings 20b and 30b, which are generally similar to the stampings 20 and 30 of FIGS. 5-12. The seal assembly 10b does not include a separate ring, however. Therefore, as described below, the seal assembly 10b includes a seal 80b that is made up only of seal arm portions of the two stampings 20b and 30b. The two stampings 20b and 30b are identical and so only one is described. The two stampings 20b and 30b are assembled back to back and welded or otherwise secured to each other to provide a seal between them. Only a portion of the seal assembly 10b, around one fluid flow opening 40, is shown.

The stamping 20b includes a central portion 34b that lies in a plane. The material of the stamping 20b is bent out of the plane to form a generally J-shaped seal arm 50b that defines the fluid flow opening 40 in the stamping. The J-shaped configuration includes a base leg 110 and an end portion 112 that curves 180 degrees from the base leg 110. The curved end portion 112 has a curved outer side surface 114.

When the two stampings 20b and 30b are assembled back to back as shown in FIGS. 15 and 16, the base legs 110 of the seal arms 50b are in abutting engagement. The end portions 112 of the seal arms 50b spread out from each other.

When the seal assembly 10b is placed between the two components 24 and 26 as shown schematically in FIG. 15, the curved outer side surface 114 of the end portion 112 of the seal arm 50b of the first stamping 20b engages the counterbore surface 84 of the first component 24. The curved outer side surface 114 of the end portion 112 of the seal arm 50b of the second stamping 30b engages the counterbore surface 88 of the second component 26. The two seal arm end portions 112 form the seal 80b of the seal assembly 10b. When the two components 24 and 26 are brought together, the seal 80b is clamped between the counterbore surfaces 84 and 88 of the components. Clamping force is transmitted from the first component 24 through the first seal arm 50b, and the second seal arm 50b, to the second component 26.

The relatively soft material of the seal arm portions 50b deforms as it engages and seals against the components 24 and 26. The stampings 20b and 30b may be made with the curved outer side surfaces 114 softer than the inner portion, or remainder, to enhance their sealing capability.

The invention thus provides a seal assembly in which two stampings seal against each other. The base legs of the two stampings seal against each other. Specifically, the base legs may have opposed polished surfaces that engage and seal against each other. Raised land areas (not shown) may be provided on the stampings, to enhance the seal between them. The stampings are also preferably welded to form a seal between them.

FIGS. 17 and 18 illustrate a seal assembly 10c in accordance with a fourth embodiment of the invention. The seal assembly 10c includes two stampings 20c and 30c, which are generally similar to the stampings of the seal assembly of FIGS. 15 and 16. The seal assembly 10c does not include a separate ring. Therefore, as described below, the seal assembly 10c includes a seal 80c that is made up only of seal arm portions of the two stampings 20c and 30c. The two stampings 20c and 30c are identical and so only one is described. The two stampings 20c and 30c are assembled back to back and welded or otherwise secured to each other to provide a seal between them. Only a portion of the seal assembly 10c, around one fluid flow opening 40, is shown.

The stamping 20c includes a central portion 34c that lies in a plane. The material of the stamping 20c is bent out of the plane to form a generally J-shaped seal arm 50c that partially defines the fluid flow opening 40 in the stamping. The J-shaped configuration includes a base leg 120 and an end portion 122 that curves 90 degrees from the base leg. The curved end portion 122 has a flat terminal end surface 126.

The two stampings 20c and 30c are assembled back to back as shown in FIGS. 17 and 18. The base legs 120 of the seal arms 50c are in abutting engagement. The end portions 122 of the seal arms 50c spread out from each other. The two seal arm end portions 50c form the seal 80c of the seal assembly 10c.

When the seal assembly 10c is placed between the two components 24 and 26 as shown schematically in FIG. 17, the terminal end surfaces 126 of the stampings 20c and 30c engage the counterbore surfaces 84 and 88 of the components. When the two components 24 and 26 are brought together, the seal 80c is clamped between the counterbore surfaces 84 and 88 of the components. Clamping force is transmitted from the first component 24 through the first seal arm 50c and the second seal arm 50c, to the second component 26.

The relatively soft material of the seal arm portions 50c deforms as it engages and seals against the components 24 and 26. The stampings 20c and 30c may be made with terminal end portions that are softer than the inner portion, or remainder, to enhance their sealing capability.

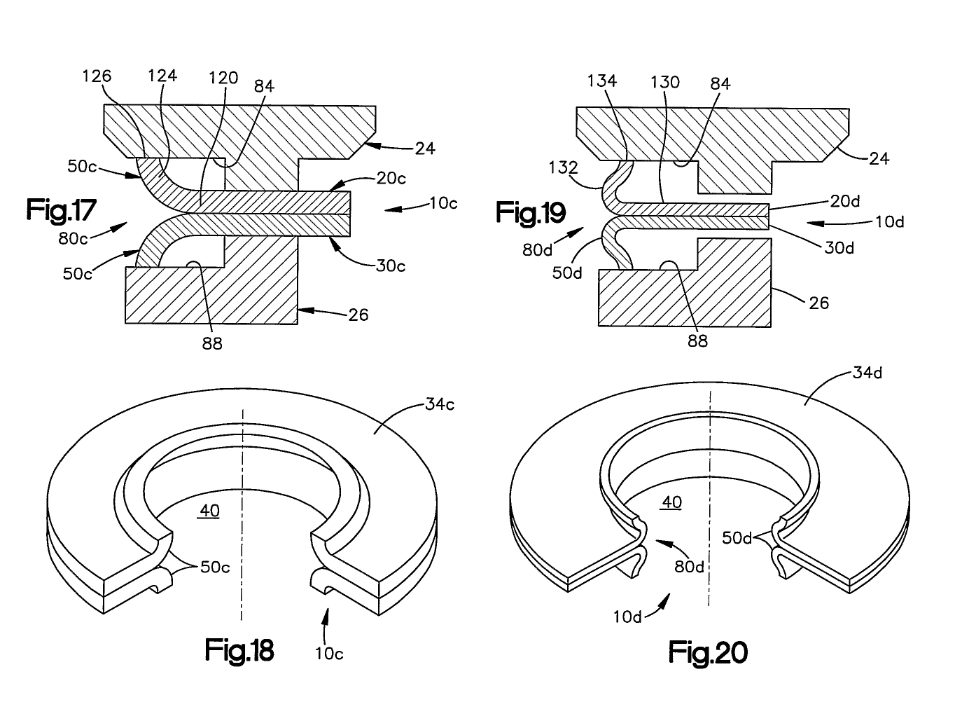

FIGS. 19 and 20 illustrate a seal assembly 10d in accordance with a fifth embodiment of the invention. The seal assembly 10d includes two stampings 20d and 30d, which are generally similar to the stampings of the seal assembly of FIGS. 15 and 16. The seal assembly 10d does not include a separate ring. Therefore, as described below, the seal assembly 10d includes a seal 80d that is made up only of seal arm portions of the two stampings 20d and 30d. The two stampings 20d and 30d are identical and so only one is described. The two stampings 20d and 30d are assembled back to back and welded or otherwise secured to each other to provide a seal between them. Only a portion of the seal assembly 10d, around one fluid flow opening 40, is shown.

The stamping 20d includes a central portion 34d that lies in a plane. The material of the stamping 20d is bent out of the plane to form a seal arm 50d that partially defines the fluid flow opening 40 in the stamping. The seal arm 50d includes a base leg 130 and an end portion 132 that curves about 135 degrees back toward the base leg then about 45 degrees outward to provide a flat terminal end surface 134 that faces radially inward and defines the fluid flow opening 40.

The two stampings 20d and 30d are assembled back to back as shown in FIGS. 19 and 20. The base legs 130 of the seal arms 50d are in abutting engagement. The end portions 132 of the seal arms spread out from each other. The two seal arm end portions 132 form the seal 80d of the seal assembly 10d.

When the seal assembly 10d is placed between the two components 24 and 26 as shown schematically in FIG. 19, the end portions 132 of the stampings 20d and 30d engage the counterbore surfaces 84 and 88 of the components. When the two components 24 and 26 are brought together, the seal 80d is clamped between the counterbore surfaces 84 and 88 of the components. Clamping force is transmitted from the first component 24 through the two seal arms 50d to the second component 26. The double curved configuration of the seal arms 50d can provide resilience to the seal arms while they are forced toward each other. The relatively soft material of the seal arm portions 50d deforms as it engages and seals against the components 24 and 26. The stampings 20d and 30d may be made with terminal end portions that are softer than the inner portion, or remainder, to enhance their sealing capability.

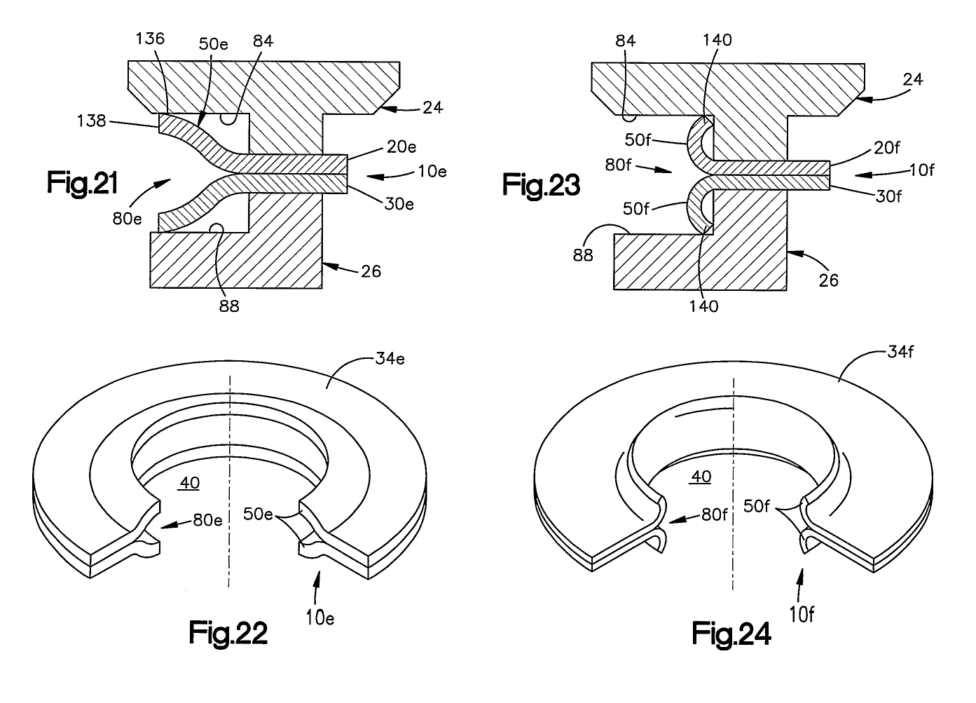

FIGS. 21 and 22 illustrate a seal assembly 10e in accordance with a sixth embodiment of the invention. The seal assembly 10e includes two stampings 20e and 30e, which are generally similar to the stampings of the seal assembly of FIGS. 15 and 16. The seal assembly 10e does not include a separate ring. Therefore, as described below, the seal assembly 10e includes a seal 80e that is made up only of seal arm portions 50e of the two stampings 203 and 30e. The two stampings 20e and 30e are identical and so only one is described. The two stampings 20e and 30e are assembled back to back and welded or otherwise secured to each other to provide a seal between them. Only a portion of the seal assembly 10e, around one fluid flow opening 40, is shown.

The stamping 20e includes a central portion 34e that lies in a plane. The material of the stamping 20e is bent at about 45 degrees out of the plane to form a seal arm 50e that partially defines the fluid flow opening 40 in the stamping. The seal arm 50e has a curved outer side surface 136 that faces outward away from the plane of the central portion 34e, and a flat terminal end surface 138.

The two stampings 20e and 30e are assembled back to back as shown in FIGS. 19 and 20. The seal arms 50e spread out from each other. The two seal arms 50e form the seal 80e of the seal assembly 10e. When the seal assembly 10e is placed between the two components 24 and 26 as shown schematically in FIG. 19, the outer side surfaces 136 of the stampings 20e and 30e engage the counterbore surfaces 84 and 88 of the components. When the two components 24 and 26 are brought together, the seal 80e is clamped between the counterbore surfaces 84 and 88 of the components. Clamping force is transmitted from the first component 24 through the first and second seal arms 50e to the second component 26. The curved configuration of the seal arms 50e can provide resilience to the seal arms while they are forced toward each other. The relatively soft material of the seal arm portions deforms as it engages and seals against the components 24 and 26. The stampings 20e and 30e may be made with outer side surfaces, or end portions, that are softer than the inner portion, or remainder, to enhance their sealing capability.

FIGS. 23 and 24 illustrate a seal assembly 10f in accordance with a seventh embodiment of the invention. The seal assembly 10f includes two stampings 20f and 30f, which are generally similar to the stampings of the seal assembly of FIGS. 15 and 16. The seal assembly 10f does not include a separate ring. Therefore, as described below, the seal assembly 10f includes a seal 80f that is made up only of seal arm portions 50f of the two stampings 20f and 30f. The two stampings 20f and 30f are identical and so only one is described. The two stampings 20f and 30f are assembled back to back and welded or otherwise secured to each other to provide a seal between them. Only a portion of the seal assembly 10f, around one fluid flow opening 40, is shown.

The stamping 20f includes a central portion 34f that lies in a plane. The material of the stamping 20f is bent back about 135 degrees out of the plane to form a seal arm 50f that partially defines the fluid flow opening 40 in the stamping. The seal arm 50f has a terminal end portion 140.

The two stampings 20f and 30f are assembled back to back as shown in FIGS. 19 and 20. The seal arms 50f spread out from each other. The two seal arm end portions 140 form the seal 80f of the seal assembly 10f.

When the seal assembly 10f is placed between the two components 24 and 26 as shown schematically in FIG. 19, the terminal end portions 140 of the stampings 20f and 30f engage the counterbore surfaces 84 and 88 of the components. Specifically, the terminal end portions 140 are wedged into the corners of the counterbores in the components 24 and 26. When the two components 24 and 26 are brought together, the seal 80f is clamped between the counterbore surfaces 84 and 88 of the components. Clamping force is transmitted from the first component 24 through the seal arms 50f to the second component 26. The wedging of the seal arms 50f into the corners of the counterbores can help to enhance their sealing capability.

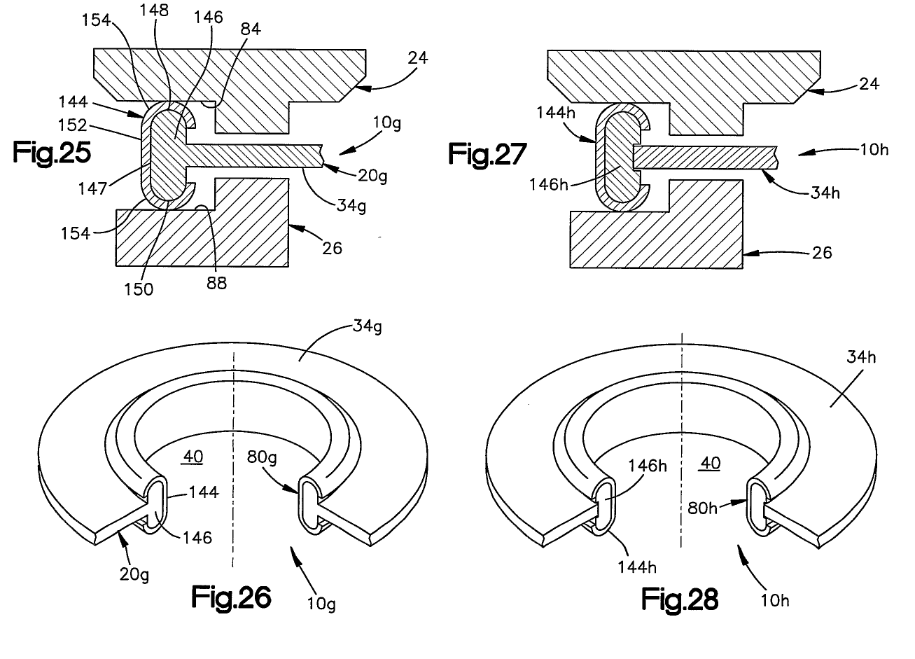

FIGS. 25 and 26 illustrate a seal assembly 10g in accordance with an eighth embodiment of the invention. The seal assembly 10g includes a single stamping 20g, and a separate sealing sleeve 144.

The stamping 20g has a central portion 34g that lies in a plane. The stamping 20g also includes an annular ring portion 146 that extends around and defines the fluid flow opening 40. The outer configuration of the ring portion 146 is similar to the outer configuration of the ring seal 80a shown in FIGS. 13 and 14. The ring portion 146 has a flat outer side surface 147 and opposite curved outer surfaces 148 and 150 that face away from each other. The ring portion 146 of the stamping 20g is preferably hardened.

The sealing sleeve 144 is made from a softer material than the ring portion 146 of the stamping 20g. The sealing sleeve 144 has a generally C-shaped cross-sectional configuration as seen in FIGS. 26 and 27. The C-shaped configuration includes a base portion 152 and two arm portions 154. The sleeve 144 is wrapped around the ring portion 146 of the stamping 20g so that the base portion 152 of the sleeve overlies the flat outer side surface 147 of the ring portion 146, and the two arm portions 154 of the sleeve overlie the curved outer surfaces 148 and 150 of the ring portion. The ring portion 146 and the sleeve 144 form the seal 80g of the seal assembly 10g.

When the seal assembly 10g is placed between the two components 24 and 26 as shown schematically in FIG. 19, the seal 80g engages the counterbore surfaces 84 and 88 of the components. Specifically, the arm portions 154 of the sealing sleeve 144 are clamped between the two components 24 and 26 and the ring portion 146 of the stamping 20g. Clamping force is transmitted from the first component 24 through the first arm portion 154, the ring portion 146, and the second arm portion 154, to the second component 26. The relatively soft material of the sealing sleeve arm portions 154 deforms as it engages and seals against the components 24 and 26. The relatively hard ring portion 146 of the stamping 20g forms a backstop to firmly transmit clamping force between the two components 24 and 26 and thus enhance the seal that is formed.

The invention thus provides a seal assembly in which an outer surface portion of the seal is softer than the inner portion. The outer surface portion engages the components being clamped, to provide a better seal without damaging the components.

FIGS. 27 and 28 illustrate a seal assembly 10h in accordance with a ninth embodiment of the invention. The seal assembly 10h is similar in construction to the seal assembly 10g of FIGS. 26 and 28. A significant difference is that the seal assembly 10h is formed in three pieces rather than two—a central portion 34h, a ring portion 146h, and a sealing sleeve 144h. The central portion 34h may be made from a relatively soft material, and the ring portion 146h made from a relatively hard material. The sealing sleeve 144h is still made from a relatively soft material. As a result, when the seal assembly 10h is clamped in position as shown in FIG. 27, there is a stack of parts from hard to soft to hard to soft to hard—the component 24, the sleeve 144, the ring portion 146, the sleeve 144, and the component 26.

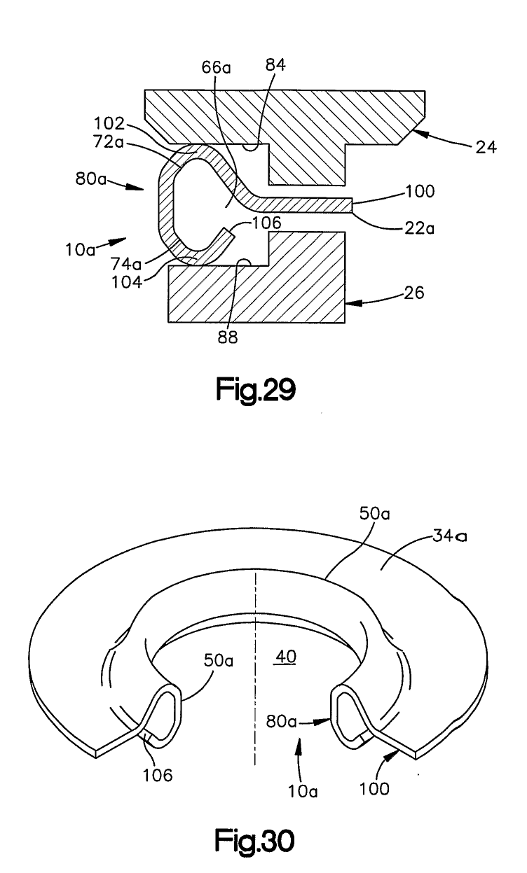

FIGS. 29 and 30 illustrate a seal assembly 10j in accordance with yet another embodiment of the invention. The seal assembly 10j is similar to the seal assembly 10a shown in FIGS. 13 and 14, but without the seal ring 70a. The seal assembly 10a thus includes only one stamping 100. As illustrated in FIG. 29, the seal assembly 10j seals between the same two components 24 and 26, in place of the seal assembly 10a of FIGS. 13-14.

When the seal assembly 10j is placed between the two components 24 and 26 as shown schematically in FIG. 29, the first seal arm portion 102 engages the counterbore surface 84 of the first component 24, and the second seal arm portion 104 engages the counterbore surface 88 of the second component 26. When the two components 24 and 26 are brought together (not shown), the seal assembly 10j is clamped between the counterbore surfaces 84 and 88 of the components. Clamping force is transmitted from the first component 24 through the seal arm portion 102 to the second component 26.

The invention also relates to a method to achieve a plastic (deformable) metal to metal seal. This can be achieved with selective hardening of the stamping. The invention further relates to a method of manufacturing a three-piece seal assembly, including two stampings and one ring. The invention also relates to a method of assembling the seal including stacking up the seal materials with the components to be sealed in a hard, soft, hard, soft, hard relationship. In addition, the invention relates to putting a three-piece seal assembly (two stampings and one ring) between the two system components.

Having described the invention, we claim:

1. A seal for sealing between first and second fluid flow components when the components are joined to each other, the first component having a first counterbore in a first surface and the second component having a second counterbore in a second surface, when the components are joined to each other the first surface overlying the second surface and the first counterbore overlying the second counterbore, the seal comprising:
a seal structure for engagement with the first and second fluid components in the first and second counterbores; and
a holding plate structure for engagement with the first and second surfaces of the first and second fluid components;
the holding plate structure including one or more layers that are formed with the first and second outer layers of the seal structure.

2. A seal as set forth in claim 1 wherein the seal includes a single piece of metal that forms the holding plate structure and the first outer layer and the second outer layer of the seal structure.

3. A seal as set forth in claim 1 wherein the holding plate structure includes first and second pieces of metal secured together, the first piece of metal forming the first layer of the holding plate structure and the first outer layer of the seal structure, the second piece of metal forming the second layer of the holding plate structure and the second outer layer of the seal structure.

4. A seal as set forth in claim 3 wherein the inner layer of the seal structure is a ring-shaped piece of metal that is formed separately from the holding plate structure and that is captured between the first and second outer layers of the seal structure.

5. A seal as set forth in claim 3 wherein the first and second pieces of metal are substantially identical to each other and are arranged in an overlying back to back relationship.

6. A seal as set forth in claim 5 wherein each one of the first and second pieces of metal is a sheet metal stamping.

7. A seal as set forth in claim 1 wherein the holding plate structure is generally planar and wherein the first and second outer layers of the seal structure project out of the plane of the holding plate structure

8. A seal as set forth in claim 1 wherein the first and second outer layers of the seal structure are circular in configuration and define fluid flow openings that align with fluid flow openings in the first and second components when the first and second components are joined to each other.

9. A seal as set forth in claim 1 that is adapted to seal between first and second components that have edges defining the first and second counterbores, respectively, the holding plate structure having a raised land area adjacent the seal structure that is engageable by one of the component edges and that is indented to resist shear slip of the seal between the first and second components.

10. A seal as set forth in claim 3 having at least two fluid openings and having slits located at predetermined positions between the fluid openings to facilitate material movement.

11. A seal as set forth in claim 1 that is made from stainless steel.

12. A seal for sealing between first and second fluid flow components when the components are joined to each other, the first component having a first counterbore in a first surface and the second component having a second counterbore in a second surface, when the components are joined to each other the first surface overlying the second surface and the first counterbore overlying the second counterbore, the seal comprising:
a seal structure for engagement with the first and second fluid components in the first and second counterbores; and
a holding plate structure connected with the seal structure for engagement with the first and second surfaces of the first and second fluid components;
the seal structure comprising at least three abutting layers of metal including first and second outer layers for engagement with the first and second fluid components and an inner layer, the first and second outer layers having a hardness that is selected to be less than the hardness of the counterbores of the first and second components, the inner layer having a hardness that is selected to be greater than the hardness of the first and second outer layers;
the inner layer of the seal structure transmitting force between the outer layers when the components are joined together with the seal structure in the counterbores.

13. A seal as set forth in claim 12 wherein the first and second outer layers of the seal structure are formed with the holding plate structure.

14. A seal as set forth in claim 13 wherein the holding plate structure is formed from only one piece of metal that includes also the first and second outer layers of the seal structure.

15. A seal as set forth in claim 13 wherein the holding plate structure is formed from first and second layers of metal joined together, the first outer layer of the seal structure is formed with the first layer of metal, and the second outer layer of the seal structure is formed with the second layer of metal.

16. A seal as set forth in claim 12 wherein the inner layer is a seal ring that is formed separately from the holding plate structure and that is captured by the first and second outer layers of the seal structure, the outer layers being clamped by the first and second counterbores against the seal ring when the components are joined together with the seal structure in the counterbores.

17. A seal as set forth in claim 12 wherein the holding plate structure is made from a generally planar metal structure that also has non-planar portions that form the first and second outer layers of the seal structure.

18. A method of achieving a metal to metal seal between two relatively hard metal components in a fluid system, comprising the steps of:
providing a metal seal that includes a seal structure and a holding plate structure, the seal structure including two relatively soft seal elements and one relatively hard seal ring captured between the seal elements;
placing the seal between the two fluid system components so that the two seal elements sealingly engage counterbores of the fluid system components with the seal ring between them thereby providing a stack of metal members that are arranged in a hard, soft, hard, soft, hard order and
transmitting force through the stack of metal members to maintain a seal between the fluid components without contact between the fluid components and the relatively hard seal ring.

19. A method as set forth in claim 18 wherein the step of transmitting force through the stack of metal members includes:
indenting a raised land portion of the seal with one or more edges of the counterbores of the first and second components thereby to resist shear slip of the seal between the first and second components.

20. A method as set forth in claim 18 wherein
the step of providing a metal seal includes providing a metal seal in which the seal elements are formed with the holding plate structure; and
the step of placing the seal between the two fluid system components includes supporting the seal structure with the holding plate structure during assembly of the seal between the two fluid system components.

21. A seal for sealing between first and second fluid flow components when the components are joined to each other, the first component having a first planar surface and the second component having a second planar surface, when the components are joined to each other the first planar surface overlying the second planar surface, the seal comprising:
a seal structure for engagement with the first and second planar surfaces of the first and second fluid components; and
a holding plate structure for engagement between the first and second fluid components;
the holding plate structure including one or more layers that are formed with the first and second outer layers of the seal structure.

22. A seal as set forth in claim 21 wherein the first planar surface is a counterbore in the first component and the second planar surface is a counterbore in the second component.

23. A fluid system including:
a substrate;
a plurality of fluid components mounted on the substrate;
a fitting associated with the substrate for directing fluid to flow between the components; and
a plurality of seals for sealing between the components and the substrate;
each one of the seals including a seal structure comprising three layers of metal with a relatively soft inner layer and two relatively hard outer layers, each seal also including a holding plate structure for engagement between the substrate and one of the components, the holding plate structure being formed with the seal structure.

24. A system as set forth in claim 23 wherein the components are fluid components such as regulators, valves, flow meters, mass flow controllers, and check valves.

25. A seal comprising:
a seal structure; and
a holding plate structure;
the seal structure comprising three layers of metal with a relatively soft inner layer and two relatively hard outer layers;
the holding plate structure being formed with the seal structure.

26. A seal as set forth in claim 25 wherein the holding plate structure includes one or more layers of metal that are formed with the outer layers of the seal structure.

27. A seal as set forth in claim 26 wherein the seal includes two metal stampings, each of which includes one layer of metal in the holding plate structure and one of the two outer layers of the seal structure.
